(19) United States
(12) Patent Application Publication
(10) Pub. No.: US 2007/0088651 A1
(43) Pub. Date: Apr. 19, 2007

(54) Method of trading securities

(75) Inventors: James R. Burgess, Coto de Caza, CA (US); Andrew M. Evans, South Yarra (AU)

Correspondence Address: DLA PIPER RUDNICK GRAY CARY US, LLP, 2000 UNIVERSITY AVENUE, E. PALO ALTO, CA, 94303-2248, US

(73) Assignee: Optioneer, LLC

(21) Appl. No.: 11/254,381

(22) Filed: Oct. 19, 2005

(51) Int. Cl. G06Q 40/00

(52) U.S. Cl. 705/37

(57) ABSTRACT

A method and a system for setting up a security trade over a network are presented. The method entails calculating a call strike price and a put strike price based on the current market price and a probability factor. A sale is recommended for a predetermined number of call options at the call strike price and the predetermined number of put options at the put strike price. A purchase of a put and call inside protections are recommended at about x points above the put strike price and at about y points below the call strike price, respectively, wherein x and y are determined according to a general level of risk participants are comfortable with. Call outside protection and put inside protection are recommended to be purchased outside the call and put strike prices.

### FIELD OF INVENTION

The invention relates generally to securities trading and particularly to trading options online.

### BACKGROUND

Option trading, which is a well known form of securities trading, is based on a contract between a buyer and a seller. Typically, the buyer of an option purchases, through payment of the option premium, the right but not the obligation to buy (call option) or to sell (put option) a certain financial instrument at a predetermined strike price at or before a predetermined expiration date for a preselected account. The seller of the option assumes the responsibility of selling the underlying security or commodity at a fixed price (call), or to buy it (put), if the buyer makes use of his/her right to exercise the option. The seller collects the option premium from the buyer, and the buyer can only exercise his right subject to the terms and conditions that define the contract.

The strike point and expiration date are agreed upon between the buyer and the seller based on the buyer and the seller's prediction on how the market will move in the future. For example, John Doe might buy the option to purchase (i.e., a put option for) 100 shares of Security X by June 19 at the strike price of $13/share. John would exercise this call option if the market price of Security X is higher than $13/share on or before June 19, so that the option effectively allows him to purchase the security at a discount price. John would want the strike price to be as low as possible. However, Jane, the option seller, would not sell the option to John if the strike price were so low that the market price of Security X is almost surely going to exceed the strike price on or before June 19. Thus, for there to be an agreement, the agreed strike price is usually what John believes will be lower than the market price of Security X on or before June 19 and what Jane believes will likely be higher than the market price of Security X on or before June 19. If the strike point is higher than the market price of Security X before and on June 19, John will likely not exercise his option and Jane collects the option premium without a transaction. If, on the other hand, the strike point is lower than the market price of Security X on June 19, John will exercise his option and Jane will have to sell John 100 shares of Security X at a below-market price.

Historically, about 70% of all options held to expiration expire unexercised by the buyer. In other words, 70% of options held to expiration result in favor of the option seller. Although these statistics do not necessarily mean that 70% of all sellers of options are profitable, it indicates that a method for option sellers to conveniently engage in trades could be in demand. A system and method for option sellers to conveniently set up and monitor the trades is desired.

### SUMMARY

In one aspect, the invention is a method of setting up a security trade over a network. The method entails receiving a selection for a trade, determining a current market price for the selected trade, and calculating a call strike price and a put strike price based on the current market price and a probability factor. A sale is recommended for a predetermined number of call options at the call strike price and the predetermined number of put options at the put strike price, wherein the predetermined number is greater than one, and a purchase of a put inside protection is recommended at x points above the put strike price. A purchase of a call inside protection is recommended at y points below the call strike price.

In another aspect, the invention is a computer-readable medium having computer-executable instructions thereon for the above method.

In yet another aspect, the invention is a system for authenticating electronically exchanged messages. The system includes a client computer and a trading computer connected to the client computer via a network. The trading computer is programmed with instructions to receive a selection for a trade from the client computer, determine a current market price for the selected trade, and calculate a call strike price and a put strike price based on the current market price and a probability factor. The trading computer is also programmed to recommend the client computer to sell a first number of call options at the call strike price and the first number of put options at the put strike price, wherein the predetermined number is greater than one. The trading computer is also programmed to recommend a purchase of a second number of put inside protection at about 20 points above the put strike price, recommend a purchase of the second number of call inside protection at about 15 points below the call strike price, recommend a purchase of a third number of put outside protection at a point below the put strike price, and recommend a purchase of the third number of call outside protection at a point above the call strike price. The ratio of the first number to the second number to the third number is 4:1:3.

In yet another aspect, the invention is a method of setting up a security trade by presenting multiple panes in a user interface. The first pane shows numerical values for a call strike price, a put strike price, price for a put inside protection, price for a call inside protection, price for a put outside protection, and price for a call outside protection. The second pane shows a chart with security prices indicated along an axis and the call strike price, a put strike price, price for a put inside protection, price for a call inside protection, the price for a put outside protection, and the price for a call outside protection marked on the chart. Inputs are received from a trader in the form of an adjusted numerical value in the first pane or change of a price marking on the chart in the second pane.

### BRIEF DESCRIPTION OF THE DRAWINGS

FIG. 1 is a general overview of the online trading system, which includes a trading computer, client, and brokers.

FIG. 2A and FIG. 2B illustrates an embodiment of the trading system employing the Hybrid strategy.

FIG. 3 illustrates an embodiment of the trading system employing the Iron Condor strategy.

FIGS. 4A and 4B are exemplary screen shots of a web page that the client would see upon initially sending the trading computer a request to set up a trade.

FIG. 5 is a screen shot of the Setting-a-Position page made available to the client by the trading computer.

FIGS. 6, 7, and 8 show examples of notices generated by the trading computer in response to client's attempt to change values in the Setting-a-Position screen of FIG. 5.

### DETAILED DESCRIPTION OF THE EMBODIMENT(S)

Embodiments of the invention are described herein in the context of an index option selling system. However, it is to be understood that the embodiments provided herein are just exemplary embodiments, and the scope of the invention is not limited to the applications or the embodiments disclosed herein. For example, some of the basic inventive concepts disclosed herein may be adapted to the context of other securities trading.

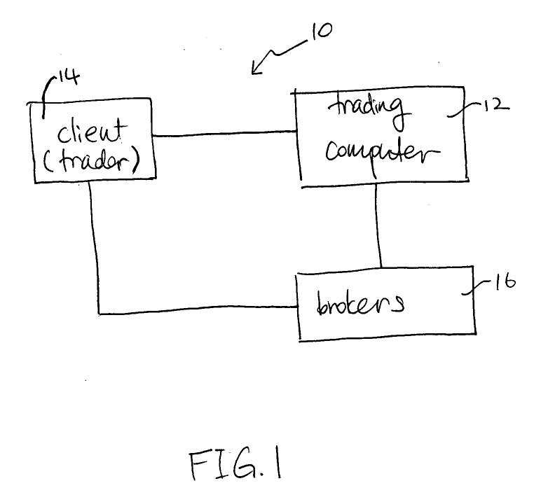

FIG. 1 is a general overview of online trading system 10, which includes a trading computer 12 that is in communication with both a client 14 and a group of brokers 16. The client 14, which usually includes a trader and his/her computer, becomes part of the online trading system 10 by opening an account with the trading computer 12. When the client 14 opens the account, s/he may also select a broker 16 or be assigned a broker 16. The trading computer 12 receives inputs from the online-trading client 14 and maintains a record of the settings (e.g., strike price, expiration date, etc.) for each client 14. The brokers 16 are able to add information to the trading computer 12 such that the client 14 can view the newly added information by accessing his/her account with the trading computer 12. The information the broker 16 may add include any market forecasts, news regarding current market conditions, any change in settings (made with the approval of the client), and market commentaries. In addition, the trading computer 12 may be set up to automatically receive daily trading numbers from another database (not shown).

The trading computer 12 is a computer having a processor and a memory. The processor in the trading computer 12 is programmed with one or more trading strategies, so that the trading computer 12 is able to “advise” the client 14 with moves the client should make to be consistent with the selected strategy. Some of the strategies recommend buying protection to hedge against potential losses.

One embodiment of the trading system 10 is an options-selling system. In this embodiment, the client 14 sells options on major indexes such as S&P, DOW Mini, and E-Mini. The client 14 may also sell options on non-U.S. indexes such as DAX German Index, STOXX Dow Jones Euro, and FTSE London Index. The options-selling embodiment may be preferable from a risk-minimization standpoint because generally, individual stocks tend to be more instable than the indexes.

One of the strategies that may be programmed into the index-option-selling embodiment of the trading computer 12 includes a Hybrid strategy, which involves the selling of Index Options on futures with differing strike prices. The Hybrid strategy would thus be a strategy for option sellers. In the Hybrid strategy, the strike prices are spaced to allow the maximum opportunity for them to expire valueless. The Hybrid strategy involves selling a put and a call in combinations. The sale of one call and put in combination is herein referred to as a “strangle.”

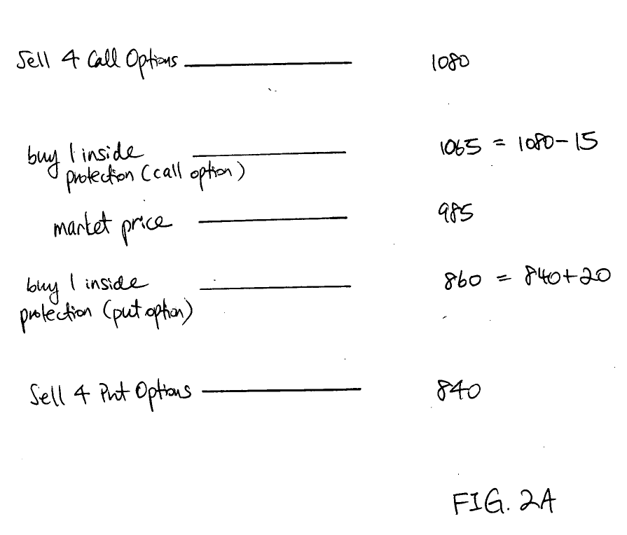

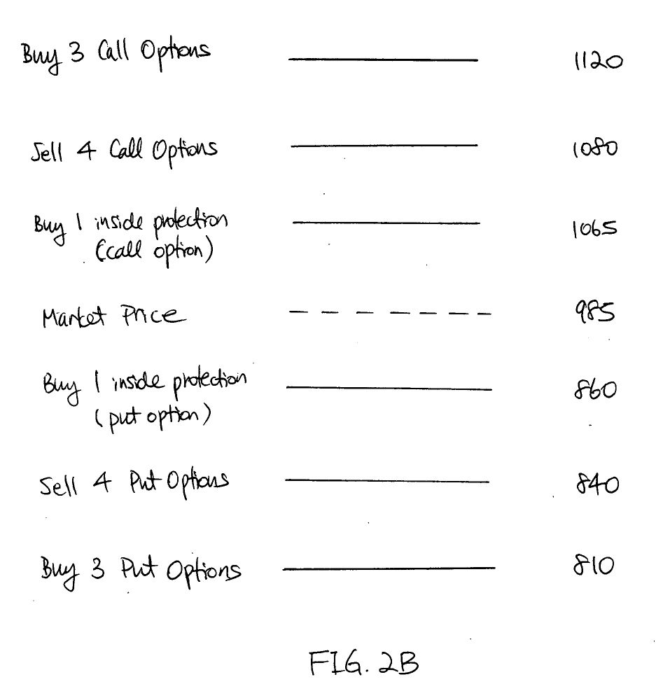

FIG. 2A illustrates an embodiment of the Hybrid strategy in which strangles are sold in groups of four. In the particular example, the market price of the option is 985. The four call options are sold at 1080 (which is 95 points above the market price), and the four put options are sold at 840 (125 points below the market price). In the Hybrid strategy, the strike prices of the four initial Puts and the four initial Calls are determined based on the Probability Factor (“P factor”). The P Factor indicates the probability of market prices reaching the sold call and put price boundaries, and may be calculated based on time to expiration, current price of the option, target boundary values, and assessed degree of risk. The invention is not limited to an exact way of calculating the P Factor, and any mathematically sensible way of calculating such probability may be employed. The P Factor calculates a minimum spread range between the sold Put and the sold Call depending on how much time is remaining in the trade. The P Factor may differ depending on the type of index. For example, it may be 11.4% for S&P 500 and 12.4% for Dow Mini.

In addition to the four sold strangles, a put inside protection and a call inside protection may be purchased. The put inside protection may be purchased at x points above the put strike price, and the call inside protection may be purchased at y points below the call strike price. The exact values of x and y depend on the amount of risk the client 14 is comfortable with, and x and y may be same as or different from each other. The Hybrid strategy recommends buying a put inside protection at about 20 points above the sold put option price (i.e., x=20), and a call inside protection at about 15 points below the sold call option price (i.e., y=15). If the Hybrid strategy recommendation is followed, a put inside protection would be purchased at 860 and a call inside protection would be purchased at about 1065in the example of FIG. 2A. This structured combination of options are designed to serve as partial protection in the event of a dramatic upswing or downturn in the market.

To further limit the amount of money that could be lost in case of a catastrophic market fluctuation, three call outside protections may be purchased above the four sold calls, and three put outside protections may be purchased below the four sold puts, as shown in FIG. 2B. Thus, the preferred Hybrid strategy entails working with a strangle:inside protection:outside protection ratio of 4:1:3. The exact position of the call and put outside protections depends on the amount of risk the client 14 is willing to take. Generally, the closer the call and put outside protections are to the prices of the sold calls and puts, respectively, the lower the risk. The trading computer 12 may make recommendations on where the call and put outside protections should be placed. For example, the trading computer 12 may recommend purchasing the outside protections where 40% annual profit is projected for the particular trade.

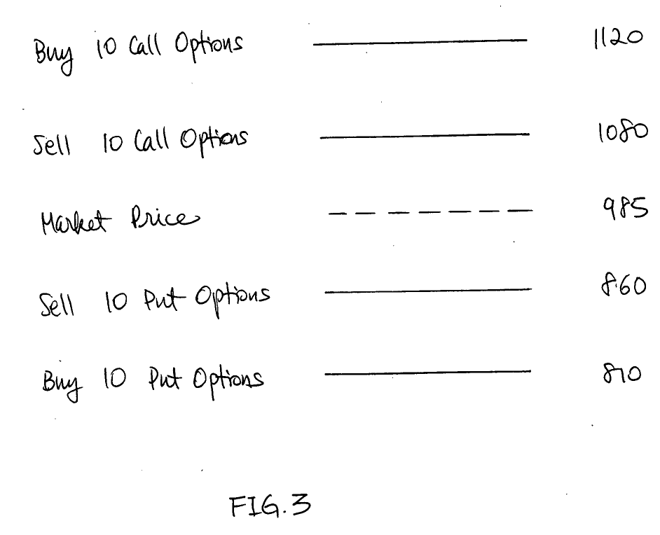

FIG. 3 illustrates a different embodiment of the trading system 10 employing a different strategy, commonly referred to as the Iron Condor strategy. With Iron Condor, strangles are purchased in multiples of one. Thus, the client 14 is recommended to purchase one Call for every sold Call, and to purchase one Put for every sold Put. These Calls and Puts are bought at a calculated distance above and below the sold positions. For example in the situation of FIG. 3 where the market price for the option is 985, a call option is sold at 1080, which is 95 points above the index. A put option is sold (with the same expiration date as the Call) at 860, which is 125 points below the index. In addition to the sold strangles, the client 14 would also purchase one Call above every one sold Call and one Put below every one sold Put for protection in case of a catastrophic market fluctuation. In the particular example shown, the client 14 bought and sold 10 of every option. However, this is not a limitation of the Iron Condor strategy.

The client 14 may access the trading computer 12 via a network that connects the two, for example the Internet. The client 14 includes a user interface (e.g., a monitor) through which web pages of the trading computer 12 may be viewed by a user.

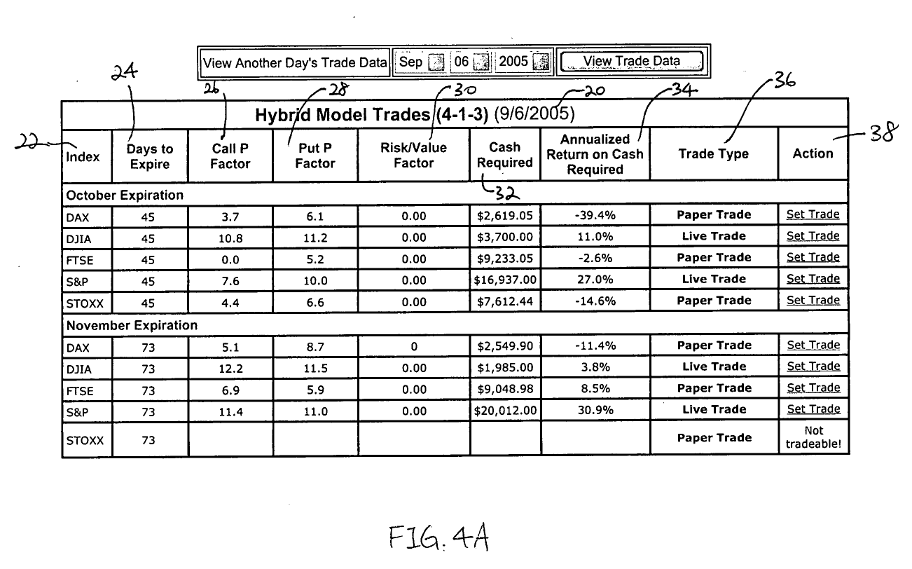

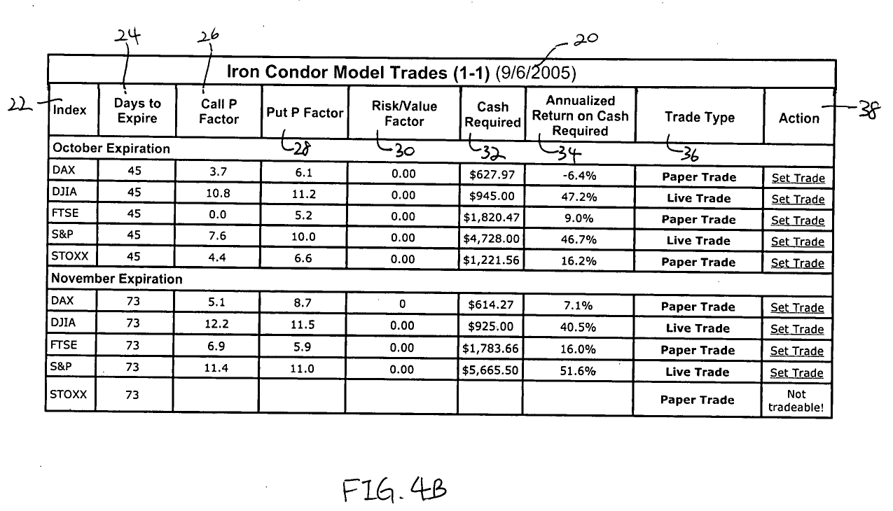

FIGS. 4A and 4B are exemplary screen shots of a web page that the client 14 would see upon initially sending the trading computer 12 a request to set up a trade. As shown, the page shows a date 20 to which the trade applies. The client 14 would be allowed to enter today's date or a date from the past up to a certain point in time. The data may be divided into Hybrid Model trades (FIG. 4A) and Iron Condor Model trades (FIG. 4B) as shown, although this is not a limitation of the invention. The possible trades may be limited, for example to trades that fall within the ≧30 days and ≦70 days time range. The web page provides basic information such as the indexes 22 that are available, the expiration date 24 for each trade, the P Factor for a call 26, the P Factor for a put 28, a risk/value factor 30, the amount of cash required 32 to enter each trade, the annualized return on cash 34 for each trade, and the trade type 36. The risk/value factor 30, which may be derived from the same formula as the P Factor, indicates when the market climate or situation is right for entering or exiting the trade. Based on these basic information, a user may select a trade and set a trade by clicking on the appropriate row in the Action 38 column.

The trade type 36 may be a live trade or a paper trade. A live trade is a real trade. Thus, upon setting up a live trade, the broker 16 will set up a trade based on instructions from the client 14. As shown in FIG. 1, the client 14 may correspond directly with the broker 16 without going through the trading computer 12. This direct channel of communication may be used for the client 14 to specify an instruction to the broker 16. More specifically, the client 14 can place a trade with the broker 16 by sending an email that is incorporated into the web site for the trading server 12, or by calling the broker 16.

As is well known, there are several different types of instructions the client 14 can give.

Some examples include:

Limit order, whereby the client 14 instructs the broker 16 to fill the order at a specified price indicated on the order, or better. With this method, there is no guarantee that the order will be filled, as the specified condition may not be fulfilled, or the particular client 14 may be at the end of a long list of traders at the same price and the orders are filled in a first-come-first-served basis.
Market order, whereby the client 14 places an order to buy or sell “at market.” With this order, the order will be executed at the best possible price once the pit broker has received it.
Stop order, whereby the client 14 instructs the broker 16 to exit the market if a certain condition is fulfilled. A “Buy” stop is placed above the market price whereas a “Sell” stop is placed below the market price.
Market-on-Close order, whereby the client 14 instructs the broker 16 to buy or sell during the last two minutes of a trading day. Frequently, these orders are executed close to the closing price for the day.
Market-on-Open order, whereby the client 14 instructs the broker 16 to buy in the first two minutes of a trading day.

The above list of orders is exemplary, and not meant to be exhaustive.

The trade type 36 may be a paper trade instead of a live trade. A paper trade is a hypothetical trade that allows the client 14 to see where s/he would end up had he entered a trade with a certain set of numbers. Unlike a live trade, which can only be entered based on today's market price, a paper trade may be conducted for a date from the past, so the client 14 can see how he would have faired had he entered a certain trade two weeks ago, for example. The paper trade option provides valuable information to the client 14 and helps him/her strategize for the next trade. If desired, certain limits may be programmed into the trading computer 12 for the paper trade. For example, paper trade may only be allowed for past dates that are more than 30 days ago.

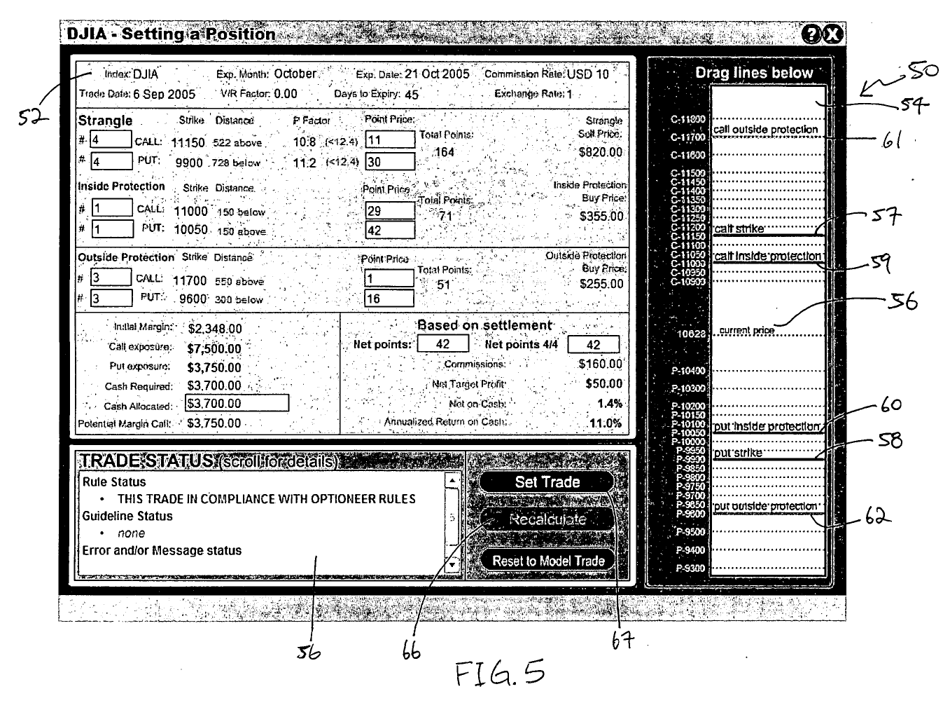

FIG. 5 is a screen shot of the Setting-a-Position page 50, which the client 14 may access by selecting a trade from the tables in FIGS. 4A and 4B and clicking on a selected one of the rows in the Action column 38. In the particular embodiment shown, the Setting-a-Position page 50 includes three panels: a numerical panel 52, a graphical panel 54, and a trade status panel 56.

The top section of the numerical panel 52 shows the basic information about the selected trade, such as the Index, expiration date, broker commission rate, etc. The numerical panel 52 also shows the strike prices of the four strangles, and provides the P factor for the four Calls and the four Puts in the strangles. Initially, the trading computer 12 provides a set of values based on its P factors. The initial set of values may be referred to as the “model trade” in the sense that they reflect the value that the trading computer 12 has determined to be the most likely to be profitable and the least likely to result in a loss. The model trades are based on strategies (e.g., Hybrid strategy, Iron Condor) that are selected by the client 14. However, the numbers of strangles, inside protection, and outside protection can be changed by the client 14. Similarly, the point prices can be changed by the client 14. A “point price” is a pricing standard for options, and indicates the dollar amount that correlates to each point in each index. For example, for the S&P 500 index, each point may represent $500. If a client changes one of the values and clicks on a Recalculate button 66, the trading computer 12 automatically adjusts all the other values such as Cash Allocated and Net Points.

The numerical panel 52 also shows the financial margin data. Before submitting a trade to the broker 16, the client 14 deposits enough money into his/her account to cover the margin that is required for the selected trade. In one embodiment, the client 14 is asked to have an account value equal to the put exposure amount unless the initial margin amount is greater. If the initial margin amount is greater than the put exposure amount, then that amount is deposited with the broker 16 before setting the trade. In the options market, values are calculated using a point system. Each point is worth a certain dollar value, and the exact dollar value depends on the relevant index. For example, one S&P point is worth $250 and one DJIA point is worth $5. The broker 16 uses these points when selling and buying options.

The graphical panel 54 includes a chart with call prices and put prices indexed along an axis. On the chart, the market price 56 is marked along with the call strike price 57, put strike price 58, call inside protection 59, and put inside protection 60. The call outside protection 61 and the put outside protection 62 are also marked. Preferably, the different sets of lines are shown in thick lines of different colors.

If the client 14 wishes to see the impact of making changes to the trading parameters, one way s/he can see the impact is by placing the mouse pointer over the thick (colored) line that is going through the strike price s/he would like to change, and dragging the thick line to a new price. The client 14 may adjust all the prices by moving the applicable thick line to the desired place on the graphical panel 54. Then, by clicking on the “Recalculate” button 66, the client 14 prompts the trading computer 12 to update the point values, spreads, and financial numbers.

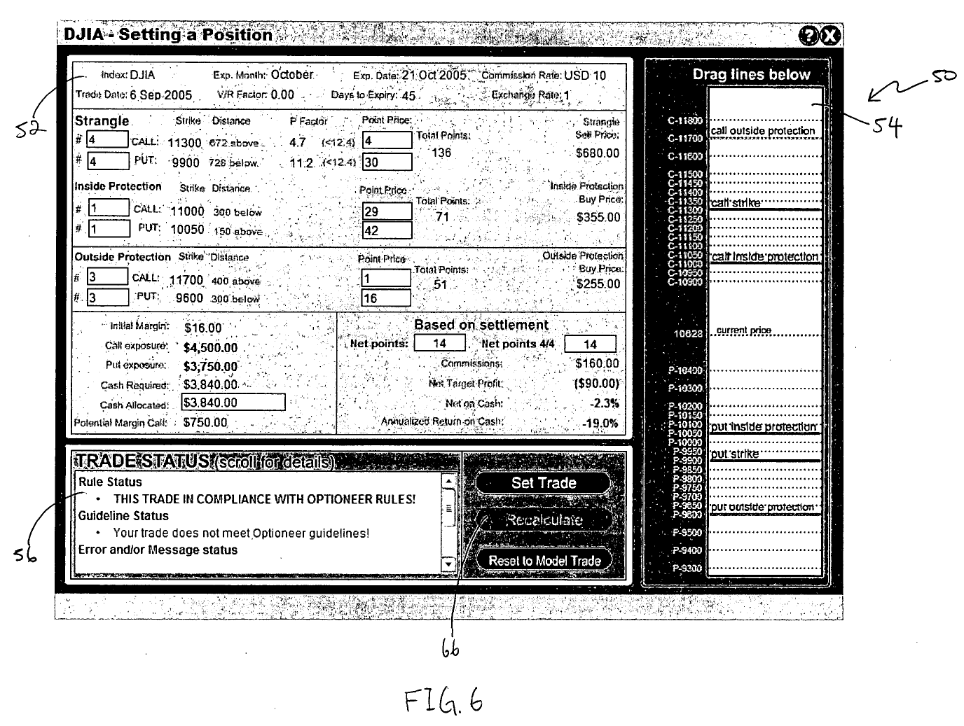

As mentioned above, the client 14 may deviate from the “model trade” by changing certain values in the Setting-a-Position screen 50. When the client deviates from the model trade, however, the Setting-a-Position screen 50 provides various notices alerting the client that s/he is deviating from the model trade guidelines. FIGS. 6, 7, and 8 show examples of these notices that the trading computer 12 generates in response to the client's attempt to change values in the Setting-a-Position screen 50 after selecting the DJIA index that expires in October under the list of Hybrid strategy trades in FIG. 4A. The client 14 may be allowed to override the warnings and proceed with the trade even if its parameters do not comply with the guidelines and rules programmed into the trading computer 12. The warning notices, however, at least provide the client 14 with a chance to think twice about his/her decision.

After all the figures are entered, the client 14 clicks on the Set Trade button 67 to submit the trade to the broker 16. Once the trade is confirmed, the trading computer 12 automatically keeps track of each trade every day. The trading computer 12 monitors each active trade to check that its Call probability factor and Put probability factor meet a certain condition, e.g. are below approximately 40%. The condition is preselected based on a statistical determination of at what probability factor value the risk exceeds the tolerance level. If the Call/Put probability factor does not meet the preselected condition, the trading computer 12 and/or the broker 16 may recommend that the client 14 take certain actions. For example, if the client 14 is still in a profitable position when the probability factor stops meeting the preselected condition, the recommendation might be to exit the trade as soon as possible. On the other hand, if the client 14 is in a loss position when the probability factor stops meeting the preselected condition, the recommendation might be to monitor the trade closely for a few days and exit upon seeing a break-even or profitable window.

FIG. 6 illustrates a case where the client 14 changed the Point Price for the Call option from 11 to 4. Note that values such as the Strangle Sell Price, Cash Allocated, and Net Target Profit are recalculated by the trading computer 12 based on this adjusted Point Price. The embodiment shown in FIG. 6 has a set of rules and a set of guidelines. In such an embodiment, a trade cannot be set up if a “rule” is violated. For example, if the rule requires that the ratio of the sold number of call options:number of purchased call inside protection:number of purchased call outside protection be 4:1:3, each trade would have to comply with this ratio to be activated. A “guideline,” on the other hand, is not a requirement. A guideline may be a recommendation by the trading computer 12, and a violation of a guideline does not prohibit setting up a trade although it may cause the generation of a warning notice. For example, while the trading computer 12 may recommend purchasing the outside protections at certain prices, the client 14 has the option to override the recommendation, or the guideline, and choose different prices for the outside protections. In FIG. 6, the trade status window 56 shows that even with the adjusted Point Price, the trade is in compliance with the general rules. However, it indicates that the trade does not meet the guidelines. As shown, the Net Target Profit in this case is a loss. Thus, although no rule is broken, the client 14 would probably not want to use the adjusted numbers.

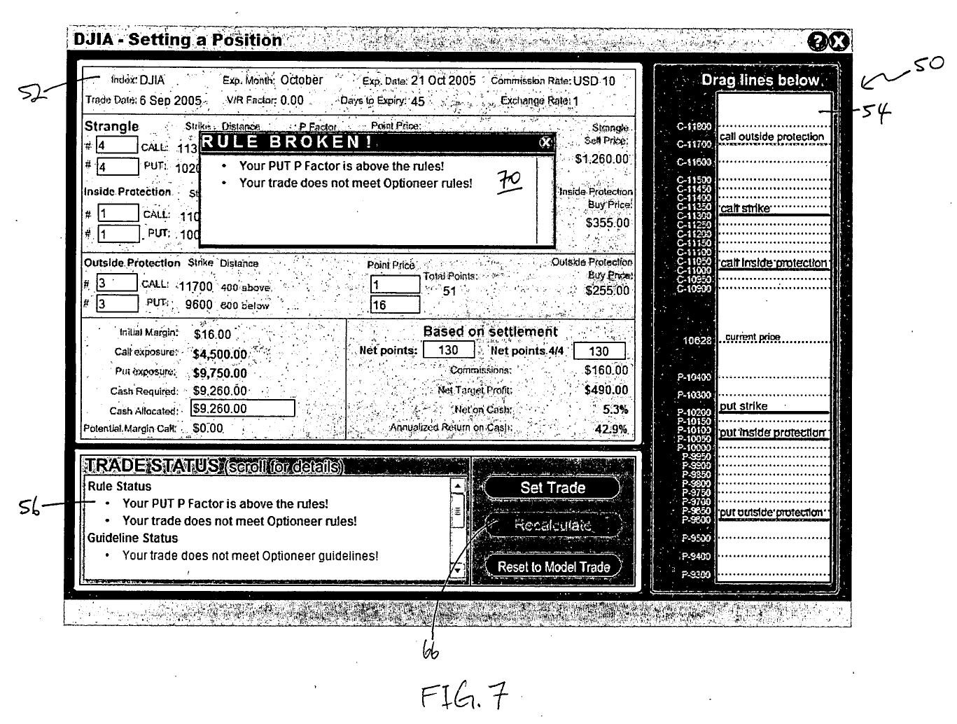

FIG. 7 illustrates a case where the client 14 changed the Point Price for the Put option to a value that drove the P factor above a preset maximum. For example, the maximum P factor may be preset to a value of 11.2 such that the trading computer 12 does not accept values from the client 14 if the values result in a P factor >11.2. As stated above, the P factor indicates the likelihood of market prices reaching the sold call and put price boundaries. The maximum P factor, thus, indicates a point beyond which the risk for the client 14 is considered to be too high by the trading computer 12. The maximum P factor limit protects the client 14 from being too aggressive with the Net Target Profit and taking on too much risk. In this case, the alert is a little more alarming than the case of FIG. 6 in that a pop-up window 70 tells the client 14 that the rule is broken.

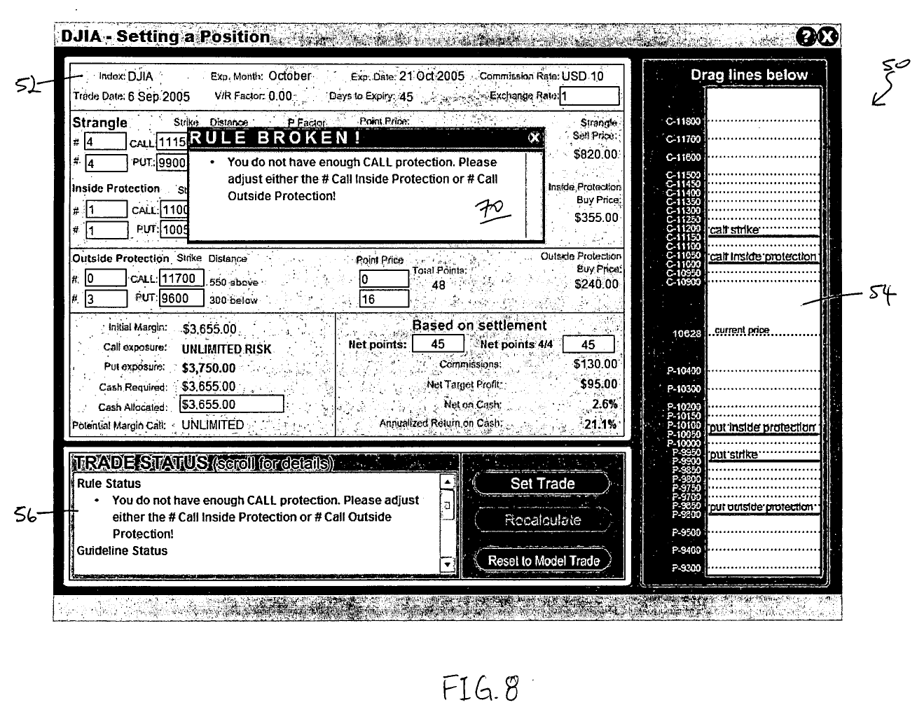

FIG. 8 illustrates a case where the client 14 tries to set up a trade without buying a call outside protection. The pop-up window 70 again appears to notify the client 14 that there is not enough call protection. With the rules that are programmed into the trading computer 12, the Hybrid model protects the client 14 from taking on too much risk or not purchasing enough protection.

When trading, a part of the strategy is determining when to enter and exit the trade. In accordance with the invention, the enter and exit decisions may be guided by the Probability Factor discussed above and the Value Factor. The Value Factor ascertains the risk inherent in the market and current option premium value in the market. The Probability Factor and the Value Factor may be posted periodically, preferably daily, on a website accessible by the client 14. Depending on the psychological makeup (e.g., comfort level with risk) and the experience level of the client 14, the client 14 may choose to continue the trade to the expiration date, exit both legs of the trade before the expiration date, or exit one leg at a time starting at a point in time before the expiration date.

Generally, the strategy programmed into the trading computer 12 recommends that the client 14 begin thinking about an exit strategy if/when the Probability Factor has climbed past the 40% mark. The trading computer 12 may also recommend exiting if the trade is more profitable than expected based on general statistics, or if the trade has made 70-80% of the profit in less than 50% of the time.

At the end of each trading day, the brokers 16 may post the closing market results on the web site available to the clients 14. Also posted are model trades, along with the Probability and Value Factors useful for the client 14 in monitoring his/her existing trades.

The trading computer 12 may also provide various information that the client 14 may use to make decisions about entering and exiting trades. For example, the trading computer 12 may provide written and/or audio files recorded daily from the trading floor that includes commentaries from floor brokers and staff. The commentaries may include the brokers' insight as to what has occurred and what to expect during the remainder of the session. The commentaries may be uploaded to the website once or more during the day. If desired, an alert may be sent to an electronic device (e.g., SMS alerts to a cell phone, electronic mail) of the client's choice whenever a commentary is uploaded, so the client is able to retrieve the comment as soon as it is uploaded.

The alert function may also be used to provide a notice to the client 14 that something happened to his/her trade. For example, the client 14 may set up the alarm preference option such that an email or SMS alert is generated if his Call/Put probability factor exceeds 40%. The client may also set up the alarm so that an email or SMS is generated if his/her trade has reached 70% of the target profit.

Although the preferred embodiment of the present invention has been described in detail hereinabove, it should be clearly understood that many variations and/or modifications of the basic inventive concepts herein taught which may appear to those skilled in the present art will still fall within the spirit and scope of the present invention.

What is claimed is:

1. A method of setting up a security trade over a network, the method comprising:
receiving a selection for a trade;
determining a current market price for the selected trade;
calculating a call strike price and a put strike price based on the current market price and a probability factor;
recommending a sale of a predetermined number of call options at the call strike price and the predetermined number of put options at the put strike price, wherein the predetermined number is greater than one;
recommending a purchase of a put inside protection at x points above the put strike price; and
recommending a purchase of a call inside protection at y points below the call strike price.

2. The method of claim 1 further comprising:
recommending a purchase of at least one call outside protection above the call strike price; and
recommending a purchase of at least one put outside protection below the put strike price.

3. The method of claim 2, wherein a ratio of the predetermined number:number of purchased put inside protection:number purchased put outside protection is 4:1:3.

4. The method of claim 2, wherein a ratio of the predetermined number:number of purchased call inside protection:number of purchased call outside protection is 4:1:3.

5. The method of claim 2 further comprising:
preparing a chart with price labeled along an axis; and
marking the call strike price, the put strike price, price of the put inside protection, price of the call inside protection, price of the call outside protections, and price of the put outside protections on the chart to provide a visual representation of a trade setup.

6. The method of claim 2 further comprising:
receiving a request for adjustment of one or more of the call strike price, the put strike price, price of the put inside protection, price of the call inside protection, prices of the put outside protections, and prices of the call outside protections; and
displaying a warning if relationships among the call strike price, the put strike price, price of the put inside protection, price of the call inside protection, prices of the put outside protections, and prices of the call outside protections do not meet a predetermined set of rules after the adjustment.

7. The method of claim 1, wherein the probability factor is calculated by using one or more of: time left to expiration of the trade, the current market price, the call and put strike prices, and degree of risk.

8. The method of claim 7, wherein the probability factor calculates a minimum spread range between the sold put options and the sold call options depending on amount of time that remains in the trade until expiration date.

9. The method of claim 1, wherein the predetermined number is four.

10. The method of claim 1 further comprising:
preparing a chart with price indexed along an axis; and
marking the call strike price, the put strike price, price of the put inside protection, and price of the call inside protection on the chart.

11. The method of claim 10 further comprising:
receiving a request to adjust one or more of the call strike price, the put strike price, price of the put inside protection, and price of the call inside protection; and
re-marking the chart to reflect the adjustment in response to the receiving of the request.

12. The method of claim 11 further comprising displaying a notice that trade parameters are not in compliance with a predetermined set of rules, wherein the rules define a relationship between the call strike price, the put strike price, the price of the put inside protection, and the price of the call inside protection.

13. The method of claim 11, wherein the request to adjust one or more of the prices comprises moving a marking on the chart up or down to adjust the price.

14. The method of claim 1, wherein the network is an Internet.

15. The method of claim 1 further comprising recommending exiting the trade if a predetermined condition is fulfilled.

16. The method of claim 1 further comprising accepting a date input that indicates which date's market data to use for determining the current market price, wherein the date is today's date or a past date.

17. The method of claim 16 wherein the date is a past date and the trade is a hypothetical trade, further comprising:
calculating the call strike price, the put strike price, the put inside protection and the call inside protection based on the market price for the past date; and
simulating a trade to show a state of the hypothetical trade today had the hypothetical trade been entered on the past date.

18. The method of claim 1 further comprising:
periodically receiving market commentaries from brokers; and
sending an alert message to traders to notify the traders that market commentaries have been received.

19. The method of claim 18, wherein the alert message is sent via an electronic mail or a short message service (SMS) signal.

20. The method of claim 20, wherein x=20 and y=15.

21. A computer-readable medium having computer-executable instructions thereon for a method of setting up a security trade over a network, the method comprising:
receiving a selection for a trade;
determining a current market price for the selected trade;
calculating a call strike price and a put strike price based on the current market price and a probability factor;
recommending a sale of a predetermined number of call options at the call strike price and the predetermined number of put options at the put strike price, wherein the predetermined number is greater than one;
recommending a purchase of a put inside protection at x points above the put strike price; and
recommending a purchase of a call inside protection at y points below the call strike price.

22. The computer-readable medium of claim 21, wherein the method further comprises:
recommending a purchase of at least one call outside protection at a point above the call strike price; and
recommending a purchase of at least one put outside protection below the put strike price.

23. The computer-readable medium of claim 22, wherein a ratio of the predetermined number:number of purchased put inside protection:number purchased put outside protection is 4:1:3.

24. The method of claim 22, wherein a ratio of the predetermined number:number of purchased call inside protection:number of purchased call outside protection is 4:1:3.

25. The computer-readable medium of claim 22, wherein the method further comprises:
preparing a chart with price labeled along an axis; and
marking the call strike price, the put strike price, price of the put inside protection, price of the call inside protection, price of the call outside protections, and price of the put outside protections on the chart to provide a visual representation of a trade setup.

26. The computer-readable medium of claim 22, wherein the method further comprises:
receiving a request for adjustment of one or more of the call strike price, the put strike price, price of the put inside protection, price of the call inside protection, prices of the put outside protections, and prices of the call outside protections; and
displaying a warning if relationships among the call strike price, the put strike price, price of the put inside protection, price of the call inside protection, prices of the put outside protections, and prices of the call outside protections do not meet a predetermined set of rules after the adjustment.

27. The computer-readable medium of claim 21, wherein the probability factor is calculated by using one or more of: time left to expiration of the trade, the current market price, the call and put strike prices, and degree of risk.

28. The computer-readable medium of claim 27, wherein the probability factor calculates a minimum spread range between the sold put options and the sold call options depending on amount of time that remains in the trade until expiration date.

29. The computer-readable medium of claim 21, wherein the predetermined number is four.

30. The computer-readable medium of claim 21, wherein the method further comprises:
preparing a chart with price indexed along an axis; and
marking the call strike price, the put strike price, price of the put inside protection, and price of the call inside protection on the chart.

31. The computer-readable medium of claim 30, wherein the method further comprises:
receiving a request to adjust one or more of the call strike price, the put strike price, price of the put inside protection, and price of the call inside protection; and
re-marking the chart to reflect the adjustment in response to the receiving of the request.

32. The computer-readable medium of claim 31, wherein the method further comprises displaying a notice that trade parameters are not in compliance with a predetermined set of rules, wherein the rules define a relationship between the call strike price, the put strike price, the price of the put inside protection, and the price of the call inside protection.

33. The computer-readable medium of claim 31, wherein the request to adjust one or more of the prices comprises moving a marking on the chart up or down to adjust the price.

34. The computer-readable medium of claim 21, wherein the network is an Internet.

35. The computer-readable medium of claim 21, wherein the method further comprises recommending exiting the trade if a predetermined condition is fulfilled.

36. The computer-readable medium of claim 21, wherein the method further comprises accepting a date input that indicates which date's market data to use for determining the current market price, wherein the date is today's date or a past date.

37. The computer-readable medium of claim 36, wherein the date is a past date and the trade is a hypothetical trade, further comprising:
calculating the call strike price, the put strike price, the put inside protection and the call inside protection based on the market price for the past date; and
simulating a trade to show a state of the hypothetical trade today had the hypothetical trade been entered on the past date.

38. The computer-readable medium of claim 21, wherein the method further comprises:
periodically receiving market commentaries from brokers; and
sending an alert message to traders to notify the traders that market commentaries have been received.

39. The computer-readable medium of claim 38, wherein the alert message is sent via an electronic mail or a short message service (SMS) signal.

40. The computer-readable medium of claim 21, wherein x=20 and y=15.

41. A system for setting up a security trade, the system comprising:
a client computer;
a trading computer connected to the client computer via a network, wherein the trading computer is programmed with instructions to
receive a selection for a trade from the client computer;
determine a current market price for the selected trade;
calculate a call strike price and a put strike price based on the current market price and a probability factor;
recommend the client computer to sell a first number of call options at the call strike price and the first number of put options at the put strike price, wherein the predetermined number is greater than one;
recommend a purchase of a second number of put inside protection at about 20 points above the put strike price;
recommend a purchase of the second number of call inside protection at about 15 points below the call strike price;
recommend a purchase of a third number of put outside protection at a point below the put strike price; and
recommend a purchase of the third number of call outside protection at a point above the call strike price;
wherein a ratio of the first number to the second number to the third number is 4:1:3.

42. A method of setting up a security trade, the method comprising:
presenting a first pane in a user interface, wherein the first pane shows numerical values for a call strike price, a put strike price, price for a put inside protection, price for a call inside protection, price for a put outside protection, and price for a call outside protection;
presenting a second pane in the user interface, wherein the second pane shows a chart with security prices indicated along an axis and the call strike price, a put strike price, price for a put inside protection, price for a call inside protection, the price for a put outside protection, and the price for a call outside protection marked on the chart; and
receiving inputs from a trader, wherein the input is either a numerical value entered in the first pane or change in the price marking on the chart in the second pane.
